(19) United States
(12) Patent Application Publication
(10) Pub. No.: US 2018/0339646 A1
(43) Pub. Date: Nov. 29, 2018

(54) IN-VEHICLE LIGHT EMITTING APPARATUS

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Atsushi Shimizu, Yokkaichi, Mie (JP)

(73) Assignees: AutoNetworks Technologies, Ltd., Yokkaichi, Mie (JP); SUMITOMO ELECTRIC INDUSTRIES, LTD., Osaka-shi, Osaka (JP); Sumitomo Wiring Systems, Ltd., Yokkaichi, Mie (JP); SUMITOMO ELECTRIC INDUSTRIES, LTD., Osaka-shi, Osaka (JP)

(21) Appl. No.: 15/559,637

(22) PCT Filed: Mar. 11, 2016
(86) PCT No.: PCT/JP2016/057757

§ 371 Date: Sep. 19, 2017

(30) Foreign Application Priority Data
Mar. 27, 2015 (JP) 2015-066856

(51) Int. Cl. B60Q 3/14; B60Q 3/16

(52) U.S. Cl. CPC B60Q 3/14; B60Q 3/16

(57) ABSTRACT

Provided is an in-vehicle light emitting apparatus that is able to use light to make a driver aware of the position of an operating part for opening a fuel lid. The in-vehicle light emitting apparatus is provided with a light emitting body provided in the interior of a vehicle that runs on fuel and a drive unit 6 that drives the light emitting body. The light emitting body is arranged in the operating part for opening the fuel lid of a refueling port provided in the vehicle or at a location from which the operating part can be illuminated.

### TECHNICAL FIELD

The present invention relates to an in-vehicle light emitting apparatus provided with a light emitting body that illuminates an operating part for opening a fuel lid of a refueling port provided in a vehicle.

### BACKGROUND ART

Vehicles that run on fuel are provided with a fuel tank and a refueling port. The refueling port is provided in a side wall rear portion of the vehicle, and the refueling port is covered by a fuel lid. An operating lever for opening the fuel lid is provided in a suitable location between the driver's seat and the side sill (e.g., Patent Document 1). The operating lever is connected to a lock mechanism of the fuel lid via a wire. As a result of the driver pulling up the operating lever, the lock mechanism is released and the fuel lid opens.

### CITATION LIST

### Patent Documents

Patent Document 1: JP 2013-249029A

### SUMMARY OF INVENTION

### Technical Problem

However, there is a problem in that the operating lever of the fuel lid is in a position that is not easily visible from the driver's seat, and is sometimes difficult to find. Also, at night, even with the interior light turned on, it sometimes takes time to find the operating lever due to the operating lever not being illuminated.

An object of the present invention is to provide an in-vehicle light emitting apparatus that uses light to make a driver aware of the position of an operating part for opening a fuel lid.

### Solution to Problem

An in-vehicle light emitting apparatus according to one aspect of the present invention is an in-vehicle light emitting apparatus including a light emitting body provided in an interior of a vehicle that runs on fuel and a drive unit configured to drive the light emitting body, in which the light emitting body is arranged in an operating part for opening a fuel lid of a refueling port provided in the vehicle or at a location from which the operating part can be illuminated.

Note that the instant invention can be realized not only as an in-vehicle light emitting apparatus that is provided with such characteristic processing units, but can also be realized as a light emitting method in which the characteristic processing is implemented as steps or as a program for causing a computer to execute these steps. Also, the instant invention can be realized as a semiconductor integrated circuit that realizes part or all of the in-vehicle light emitting apparatus, or can be realized as another system that includes the in-vehicle light emitting apparatus.

### Advantageous Effects of Invention

According to the above, it becomes possible to provide an in-vehicle light emitting apparatus that uses light to make a driver aware of the position of an operating part for opening a fuel lid.

### BRIEF DESCRIPTION OF DRAWINGS

FIG. 1 is a block diagram showing one exemplary configuration of an in-vehicle light emitting apparatus according to a first embodiment of the present invention.

FIG. 2 is a schematic diagram showing a light emitting body provided in an operating part of a fuel lid.

FIG. 3 is a flowchart showing a processing procedure of light emission control according to the first embodiment.

FIG. 4 is a flowchart showing a processing procedure of light emission control according to a second embodiment.

FIG. 5 is a flowchart showing a processing procedure of threshold value determination according to a third embodiment.

FIG. 6 is a block diagram showing one exemplary configuration of an in-vehicle light emitting apparatus according to a fourth embodiment.

FIG. 7 is a flowchart showing a processing procedure of light emission control according to the fourth embodiment.

FIG. 8 is a flowchart showing a processing procedure of light emission control according to a fifth embodiment.

FIG. 9 is a flowchart showing a processing procedure of light emission control according to a sixth embodiment.

### DESCRIPTION OF EMBODIMENTS

### Description of Embodiments of Present Invention

Embodiments of the present invention will initially be described in enumerated form. Also, the embodiments that will be described below may be suitably combined at least in part.

(1) An in-vehicle light emitting apparatus according to one aspect of the present invention is an in-vehicle light emitting apparatus including a light emitting body provided in an interior of a vehicle that runs on fuel and a drive unit configured to drive the light emitting body, in which the light emitting body is arranged in an operating part for opening a fuel lid of a refueling port provided in the vehicle or at a location from which the operating part can be illuminated.

In the instant invention, a light emitting body is arranged in an operating part for opening a fuel lid, and a drive unit causes the light emitting body to emit light. Accordingly, the driver of the vehicle is able to be aware of the position of the operating part by relying on the light that is emitted by the light emitting body.

Also, the light emitting body need not necessarily be arranged in the operating part itself, and it is sufficient if the light emitting body is arranged at a location from which the operating part can be illuminated. The driver of the vehicle is able to be aware of the position of the operating part, by confirming the location that is illuminated by the light from the light emitting body.

(2) A configuration is preferably adopted in which the in-vehicle light emitting apparatus includes a remaining amount detection unit configured to detect a remaining amount of fuel, and the drive unit causes the light emitting body to emit light, in a case where the remaining amount detected with the remaining amount detection unit is less than a threshold value.

In the instant invention, a remaining amount detection unit detects the remaining amount of fuel. The drive unit causes the light emitting body to emit light, in the case where the remaining amount of fuel decreases to less than a threshold value. Accordingly, in the case where a state is entered in which the fuel lid needs to be opened, the operating part can be illuminated by causing the light emitting body to emit light.

Also, by preventing needless light emission of the light emitting body, power consumption in the vehicle can be reduced. Furthermore, the driver can also be made aware of a reduction in fuel by the light emission of the light emitting body.

The threshold value may be a fixed value, or may be a value that changes depending on a learning result such as in aspect (3). Also, the fixed value may be set to a suitable value by a user or may be selectable.

(3) A configuration is preferably adopted in which the in-vehicle light emitting apparatus includes a remaining amount storage unit configured to store the amount of fuel remaining when refueling is performed, and a threshold value determining unit configured to determine the threshold value, based on the remaining amount stored in the remaining amount storage unit.

In the instant invention, a remaining amount storage unit stores the amount of fuel remaining when refueling is performed. Although the timing for refueling differs depending on the driver, information indicating the tendency of the driver as to the remaining amount at which he or she refuels can be accumulated, by storing the remaining amount in the remaining amount storage unit. In other words, the remaining amount storage unit accumulates information indicating the timing at which the fuel lid needs to be opened.

A threshold value determining unit then determines the threshold value based on the remaining amount stored in the remaining amount storage unit. Accordingly, the state in which the fuel lid needs to be opened is properly determined, and the operating part can be illuminated by causing the light emitting body to emit light.

(4) A configuration is preferably adopted in which the in-vehicle light emitting apparatus includes an operational state detection unit configured to detect an operational state of an ignition switch, and the drive unit causes the light emitting body to emit light, in a case where the operational state of the ignition switch is an OFF state.

In the instant invention, in the case where the operational state of the ignition switch is an OFF state, the drive unit causes the light emitting body to emit light. In other words, when the vehicle has stopped and there is a possibility that refueling will be performed, the drive unit is able to illuminate the operating part by causing the light emitting body to emit light.

(5) A configuration is preferably adopted in which the in-vehicle light emitting apparatus includes an engine state detection unit configured to detect a state of an engine of the vehicle, and the drive unit causes the light emitting body to emit light, in a case where the engine has stopped.

In the instant invention, in the case where the engine has stopped, the drive unit causes the light emitting body to emit light. In other words, when the engine has stopped and there is a possibility that refueling will be performed, the drive unit is able to illuminate the operating part by causing the light emitting body to emit light.

(6) A configuration is preferably adopted in which the in-vehicle light emitting apparatus includes an acquisition unit configured to acquire position information of the vehicle, a filling station information acquisition unit configured to acquire position information of a filling station, and a position determination unit configured to determine, based on the position information acquired with the acquisition unit and the position information of the filling station, whether the vehicle is at the filling station, and the drive unit causes the light emitting body to emit light, in a case where it is determined that the vehicle is at the filling station.

In the instant invention, an acquisition unit acquires position information of the vehicle. A filling station information acquisition unit acquires position information of filling stations. A position determination unit then determines whether the vehicle is located at a filling station. The drive unit causes the light emitting body to emit light, in the case where the vehicle is located at a filling station. In other words, when the vehicle has stopped at a filling station and there is a possibility that refueling will be performed, the drive unit is able to illuminate the operating part by causing the light emitting body to emit light.

(7) A configuration is preferably adopted in which the in-vehicle light emitting apparatus includes an acquisition unit configured to acquire position information of the vehicle, a position storage unit configured to store position information that the acquisition unit acquires when refueling is performed, and a utilized filling station determination unit configured to determine whether a filling station is within a predetermined range from the vehicle, based on the position information acquired with the acquisition unit and the position information stored in the position storage unit, and the drive unit causes the light emitting body to emit light, in a case where it is determined that the filling station is within the predetermined range.

In the instant invention, an acquisition unit acquires position information of the vehicle, and a position storage unit stores the position of the vehicle when refueling is performed. A utilized filling station determination unit determines whether there is a filling station at which refueling was performed in the past within a predetermined range from the vehicle. The drive unit causes the light emitting body to emit light, in the case where there is a filling station at which refueling was performed in the past within the predetermined range. In other words, the drive unit is able to illuminate the operating part by causing the light emitting body to emit light, when a filling station at which there is a high possibility that refueling will be performed exists in the vicinity of the vehicle.

(8) A configuration is preferably adopted in which the in-vehicle light emitting apparatus includes an acquisition unit configured to acquire position information of the vehicle, a filling station information acquisition unit configured to acquire position information and information related to a fuel price of a filling station, a filling station determination unit configured to determine whether a filling station is within a predetermined range from the vehicle, based on the position information acquired with the acquisition unit and the position information of the filling station, and a fuel price comparison unit configured to, in a case where it is determined that the filling station is within the predetermined range, compare the fuel price of the filling station with the fuel price of another filling station, and the drive unit causes the light emitting body to emit light according to a comparison result of the fuel price comparison unit, in a case where it is determined that the filling station is within the predetermined range.

In the instant invention, an acquisition unit acquires position information of the vehicle. A filling station information acquisition unit acquires position information of filling stations and information relating to fuel prices. A position determination unit then determines whether there is a filling station within a predetermined range from the vehicle. A fuel price comparison unit compares the fuel price of a filling station that is within the predetermined range with the fuel prices of other filling stations. The drive unit causes the light emitting body to emit light according to the comparison result of the fuel price comparison unit, in the case where there is a filling station within the predetermined range. For example, the drive unit causes the light emitting body to emit light, in the case where there is a filling station where the fuel price is cheap in the vicinity of the vehicle, and extinguishes the light emitting body, in the case where the fuel price of the filling station in the vicinity of the vehicle is expensive. Adopting this configuration enables a cheaper filling station to be suggested to the driver.

Note that a configuration may be adopted in which the drive unit causes the light emitting body to be extinguished, in the case where there is a cheap filling station in the vicinity of the vehicle, and causes the light emitting body to emit light, in the case where there is an expensive filling station in the vicinity of the vehicle.

### Details of Embodiments of Present Invention

Specific examples of an in-vehicle light emitting apparatus according to embodiments of the present invention will be described hereinafter, with reference to the drawings. Note that the present invention is not limited to these illustrative examples and is defined by the claims, and all changes that come within the meaning and range of equivalency of the claims are intended to be embraced therein.

### First Embodiment

FIG. 1 is a block diagram showing one exemplary configuration of an in-vehicle light emitting apparatus according to a first embodiment of the present invention. The in-vehicle light emitting apparatus according to the first embodiment is provided with a control unit 1, a storage unit 2, a remaining fuel amount detection unit 3, an ignition switch operational state detection unit 4, an engine state detection unit 5, a drive unit 6, a light emitting body 7, and an acceptance unit 8.

The control unit 1 is a microcomputer having one or a plurality of CPUs (Central Processing Units), a multi-core CPU or the like, for example. The control unit 1 has the storage unit 2, the remaining fuel amount detection unit 3, the ignition switch operational state detection unit 4, the engine state detection unit 5 and the drive unit 6 connected thereto, and controls the operations of each of these constituent elements. For example, processing for determining whether light emission of the light emitting body 7 is required, based on information detected by the various detection units, and outputting a light emission control signal or an extinguishment control signal to the drive unit 6 according to the determination result is executed.

The storage unit 2 is a nonvolatile memory such as an EEPROM (Electrically Erasable Programmable ROM) or a flash memory. The storage unit 2 stores a control program for the control unit 1 to perform light emission control of the light emitting body 7. Also, the storage unit 2 stores a threshold value for determining the remaining amount at which the vehicle should be refueled.

The remaining fuel amount detection unit 3 is provided with a fuel level sensor, for example. The fuel level sensor has a variable resistor whose resistance value changes depending on the up-down position of a float of the fuel tank, and the remaining fuel amount detection unit 3 detects the resistance value of this variable resistor, calculates the remaining amount of fuel corresponding to this resistance value, and provides a signal indicating the remaining amount of fuel obtained through calculation to the control unit 1. Note that calculation of the remaining amount of fuel may be performed by the control unit 1.

The ignition switch operational state detection unit 4 has the ignition switch connected thereto via a signal line, and is configured to detect the operational state of the ignition switch and provide a signal indicating the operational state to the control unit 1.

The engine state detection unit 5 is, for example, an engine ECU connected to a sensor that detects the number of revolutions of the engine, and provides a signal indicating the detected number of revolutions of the engine to the control unit 1. The control unit 1 determines whether the engine is running or in a temporarily stopped state or whether the engine is in a completely stopped state, based on the signal from the engine state detection unit 5. The temporarily stopped state is a state in which it is possible to immediately restart the engine and start the vehicle moving. The completely stopped state is a state in which starting the vehicle moving is not possible without operating the ignition switch and starting the engine. Hereinafter, the case where the engine is said to be running is given as including the state in which the engine has temporarily stopped, and the engine being stopped is given as referring to the completely stopped state.

The drive unit 6 has the light emitting body 7 connected thereto, and is provided with a switching element that controls power supply to the light emitting body 7. The drive unit 6 causes the light emitting body 7 to emit light or to control by turning the switching element ON/OFF, in response to a light emission control signal or an extinguishment control signal from the control unit 1.

The acceptance unit 8 is an input interface such as a switch, a touch panel or the like for accepting an operational mode of the light emitting body 7 from a user. The in-vehicle light emitting apparatus according to this first embodiment has an IG (Ignition) switch linked mode for causing the light emitting body 7 to emit light in conjunction with the operational state of the ignition switch, together with the remaining amount of fuel, and an IG switch non-linked mode for causing the light emitting body 7 to emit light, independently of the operational state of the ignition switch. The user is able to select one of the modes by operating the acceptance unit 8, and the control unit 1 stores mode information accepted with the acceptance unit 8 in the storage unit 2. Note that the acceptance unit 8 may be configured to accept selection of a mode, using a touch panel provided in a display unit of a car navigation apparatus or an input apparatus of another in-vehicle device.

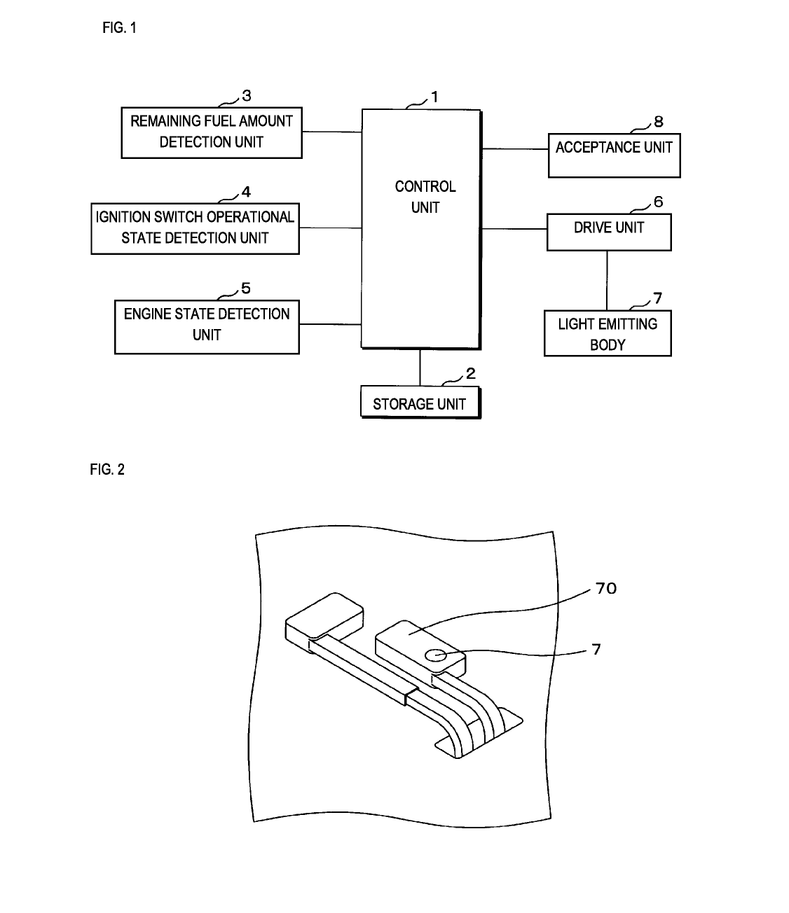

FIG. 2 is a schematic diagram showing the light emitting body 7 provided in an operating part 70 of the fuel lid. The operating part 70 for opening the fuel lid is provided in a predetermined location in the vicinity of the driver's seat. The operating part 70 is provided with an operating lever whose tip portion is formed in a tabular shape, and a base portion of the operating lever is supported in the predetermined location such that the tip portion moves rotationally up and down. The light emitting body 7 is provided in the tip portion of the operating part 70. The light emitting body 7 is an LED (Light Emitting Diode), an organic EL (Electro Luminescence) element or an incandescent light bulb, for example. The light emitting body 7 may be a point light source or may be a surface light source. Also, the light emitting body 7 may be provided on the surface of the operating part 70, or may be provided inside the operating part 70 and configured to cause the surface of the operating part 70 to emit light. In the case of arranging the light emitting body 7 inside the operating part 70, a configuration may be adopted in which a light transmissive part having a pattern indicating refueling is provided on the surface of the operating part 70, and this light transmissive part is caused to emit light. Furthermore, the light emitting body 7 need not necessarily be provided in the light emitting body 7 itself, and the light emitting body 7 may be arranged in a predetermined location from which the operating part 70 can be illuminated. For example, the light emitting body 7 may be provided in a lower portion of the driver's seat, or may be provided in a side wall on the vehicle interior side of the driver's door. Note that in the case where the light emitting body 7 is disposed at a distance from the operating part 70, this light emitting body 7 is preferably configured to emit light having directivity.

Note that a configuration may be adopted in which the operating part 70 is connected to a lock mechanism of the fuel lid via a wire, and the lock mechanism is released by the upward rotational movement of the operating part 70, opening the fuel lid.

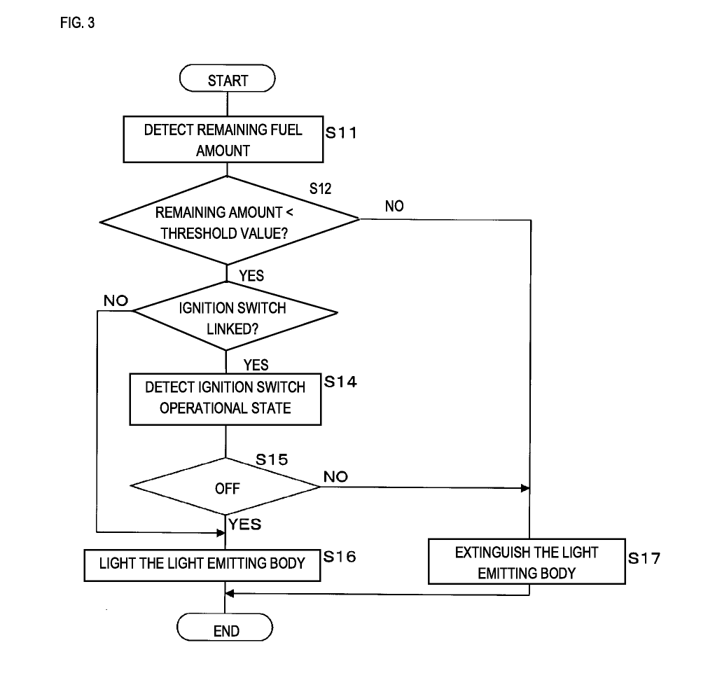

FIG. 3 is a flowchart showing a processing procedure of light emission control according to the first embodiment. The control unit 1 detects the remaining amount of fuel with the remaining fuel amount detection unit 3 (step S11), and determines whether the remaining amount of fuel is less than a threshold value (step S12). If it is determined that the remaining amount of fuel is less than the threshold value (step S12: YES), the control unit 1 determines whether the IG switch linked mode is selected, based on the mode information that is stored in the storage unit 2 (step S13). If it is determined that the IG switch linked mode is selected (step S13: YES), the control unit 1 detects the operational state of the ignition switch with the ignition switch operational state detection unit 4 (step S14), and determines whether the ignition switch is in an OFF state (step S15). If it is determined that the ignition switch is in an OFF state (step S15: YES), or if it is determined that the IG switch non-linked mode is selected in step S13 (step S13: NO), the control unit 1 outputs a light emission control signal to the drive unit 6, and the drive unit 6 causes the light emitting body 7 to emit light in accordance with this light emission control signal (step S16), and ends the processing.

If it is determined that the remaining amount of fuel is greater than or equal to the threshold value (step S12: NO), or if it is determined that the ignition switch is in an ON state (step S15: NO), the control unit 1 outputs an extinguishment control signal to the drive unit 6, and the drive unit 6 causes the light emitting body 7 to be extinguished in accordance with this extinguishment control signal (step S17), and ends the processing.

Note that although, in this first embodiment, an example was described in which the user is able to select the IG switch linked mode and the IG switch non-linked mode, the present invention is not limited to this configuration. For example, a configuration may be adopted in which selection by the user is not accepted, and only the IG switch linked mode is executed or only the IG switch non-linked mode is executed. In other words, a configuration may be adopted in which, by removing step S13, the processing after step S13 is executed without accepting selection by the user, or in the case where step S13 to step S15 are removed and the remaining fuel amount decreases to less than the threshold value, the light emitting body 7 is caused to emit light unconditionally.

With the in-vehicle light emitting apparatus according to the first embodiment constituted in this manner, the driver can be made aware of the position of the operating part 70 for opening the fuel lid by the light emission of the light emitting body 7.

Also, in the IG switch linked mode, in the case where the remaining amount of fuel decreases to less than the threshold value and the operational state of the ignition switch is the OFF state, the light emitting body 7 can be caused to emit light. Accordingly, in the case where a state is entered in which the fuel lid needs to be opened, the operating part 70 can be illuminated by causing the light emitting body 7 to emit light. The driver can also be made aware of the reduction in fuel, by the light emission of the light emitting body 7.

Since a configuration is adopted in which, in the IG switch non-linked mode, the light emitting body 7 is caused to emit light, in the case where the remaining amount of fuel is in less than the threshold value, irrespective of the operational state of the ignition switch, the driver can be made aware that the remaining amount of fuel has decreased to less than the threshold value by the light emission of the light emitting body 7 even while the vehicle is running.

Furthermore, in the IG switch linked mode, the light emitting body 7 can be extinguished, in the case where there is little need to open the fuel lid, such as where the remaining amount of fuel is greater than or equal to the threshold value or where there the ignition switch is not in the OFF state. By preventing needless light emission of the light emitting body 7, power consumption in the vehicle can be reduced.

### Second Embodiment

Since the configuration of an in-vehicle light emitting apparatus according to a second embodiment is similar to the first embodiment, and only the processing procedure of the control unit 1 differs, the following description will focus mainly on the differences. Since the remaining configuration and the operation and effect are similar to the first embodiment, the same reference signs are given to corresponding parts, and a detailed description thereof will be omitted.

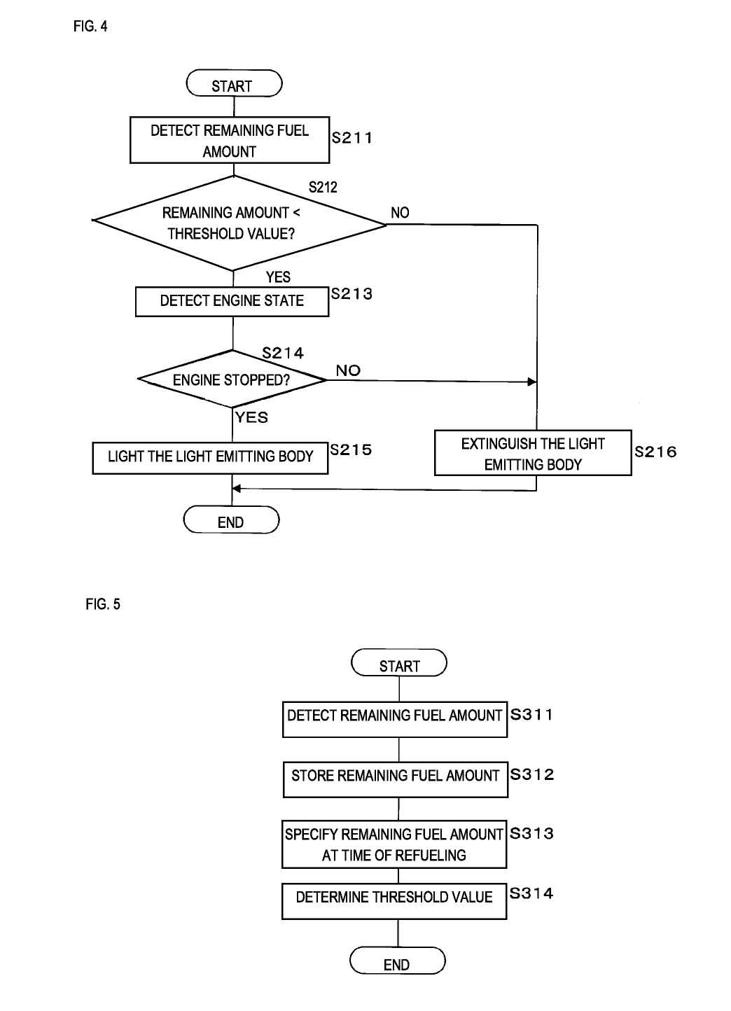

FIG. 4 is a flowchart showing a processing procedure of light emission control according to the second embodiment. The control unit 1 detects the remaining amount of fuel with the remaining fuel amount detection unit 3 (step S211), and determines whether the remaining amount of fuel is less than a threshold value (step S212). If it is determined that the remaining amount of fuel is less than the threshold value (step S212: YES), the control unit 1 detects the state of the engine with the engine state detection unit 5 (step S213), and determines whether the engine has stopped (step S214). If it is determined that the engine is in a stopped state (step S214: YES), the control unit 1 outputs a light emission control signal to the drive unit 6, and the drive unit 6 causes the light emitting body 7 to emit light in accordance with this light emission control signal (step S215), and ends the processing.

If it is determined that the remaining amount of fuel is greater than or equal to the threshold value (step S212: NO), or if it is determined that the engine is running (step S214: NO), the control unit 1 outputs an extinguishment control signal to the drive unit 6, and the drive unit 6 causes the light emitting body 7 to be extinguished in accordance with this extinguishment control signal (step S216), and ends the processing.

With the in-vehicle light emitting apparatus according to the second embodiment constituted in this manner, the light emitting body 7 can be caused to emit light and the light emitting body 7 can be extinguished, in the case where the remaining amount of fuel decreases to less than the threshold value and the engine is in a stopped state. Accordingly, in the case where a state is entered in which the fuel lid needs to be opened, the operating part 70 can be illuminated by causing the light emitting body 7 to emit light. The driver can also be made aware of the reduction in fuel, by the light emission of the light emitting body 7.

Furthermore, in the case where there is little need to open the fuel lid, such as where the remaining amount of fuel is threshold value-like or where the engine is running, the light emitting body 7 can be extinguished. Power consumption in the vehicle can be reduced, by preventing needless light emission of the light emitting body 7.

### Third Embodiment

Since the configuration of an in-vehicle light emitting apparatus according to a third embodiment is similar to the first and second embodiments, and only the processing procedure of the control unit 1 related to the threshold value differs, the following description will focus mainly on the differences. Since the remaining configuration and the operation and effect are similar to the first and second embodiments, the same reference signs are given to corresponding parts, and a detailed description thereof will be omitted.

The control unit 1 of the in-vehicle light emitting apparatus according to the third embodiment is configured to determine a threshold value, according to the amount of fuel remaining when refueling is performed, and to store the determined threshold value in the storage unit 2. In other words, the control unit 1 is configured to change the threshold value, according to the timing at which the driver refuels.

FIG. 5 is a flowchart showing a processing procedure of threshold value determination according to the third embodiment. The control unit 1 periodically executes the following processing. First, the control unit 1 detects the remaining amount of fuel with the remaining fuel amount detection unit 3 (step S311), and stores the detected remaining amount in the storage unit 2 (step S312). The control unit 1 stores the transition in the remaining amount of fuel, as a result of the processing of step S311 and step S312.

Next, the control unit 1 specifies the remaining fuel amount at the time of refueling, based on the remaining amount of fuel that is stored in the storage unit 2 (step S313). For example, the control unit 1 need only specify, as the fuel at the time of refueling, the remaining amount of fuel immediately before increasing when the remaining amount of fuel changes from decreasing to increasing. In the case where refueling has been performed a plurality of times in the past, the remaining amount of fuel at each time is specified.

The control unit 1 then calculates the average value of the remaining amount of fuel at the time of refueling, stores the average value as the threshold value (step S314), and ends the processing. Note that, in the case where the remaining amount at the time of refueling is specified only once in the processing of step S313, this remaining amount need only be stored as the threshold value. Note also that the average value of the remaining amount of fuel is one example of the threshold value, and the threshold value may be determined by other computations, such as by adding or subtracting a predetermined value to or from this average value. Also, a statistical value such as the maximum value of the remaining amount of fuel at the time of refueling in the past may be determined as the threshold value.

The control unit 1 performs light emission control of the light emitting body 7, using the threshold value thus determined. The method of light emission control is similar to the first and second embodiments.

With the in-vehicle light emitting apparatus according to the third embodiment constituted in this manner, the control unit 1 is able to determine the threshold value by the remaining amount of fuel when refueling is performed, and is thus able to more properly determine states in which the fuel lid needs to be opened, and illuminate the operating part 70 by causing the light emitting body 7 to emit light.

### Fourth Embodiment

Since the basic configuration of the in-vehicle light emitting apparatus according to a fourth embodiment is similar to the first embodiment, and only the configuration and the processing procedure of light emission control related to position detection of a filling station differ, the following description will focus mainly on the differences. Since the remaining configuration and the operation and effect are similar to the first embodiment, the same reference signs are given to corresponding parts, and a detailed description thereof will be omitted.

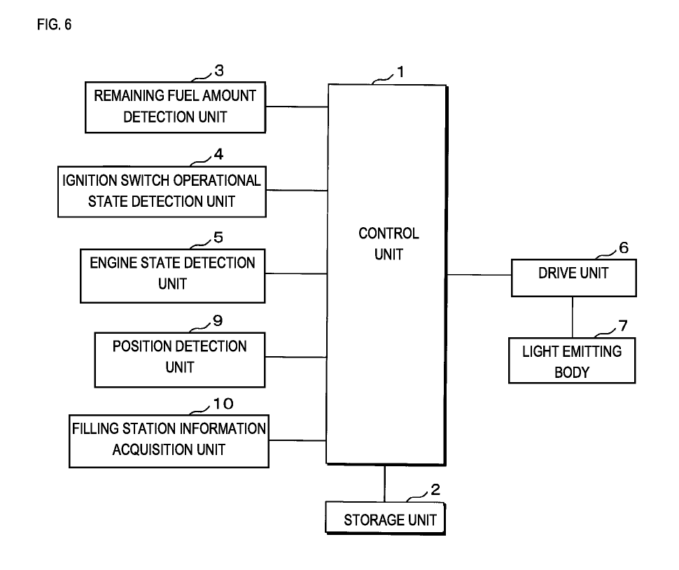

FIG. 6 is a block diagram showing one exemplary configuration of the in-vehicle light emitting apparatus according to the fourth embodiment. The in-vehicle light emitting apparatus according to the fourth embodiment is provided with a position detection unit 9 that detects the position of the vehicle in which the in-vehicle light emitting apparatus is installed and a filling station information acquisition unit 10 that acquires information related to filling stations, in addition to the configuration of the first embodiment.

The position detection unit 9 is a GPS (Global Positioning System) receiver, for example. The GPS receiver constitutes a GPS system together with GPS satellites, and is configured to receive radio waves from satellites and specify its own position, that is, the position of the vehicle. The position of the vehicle is represented by latitude and longitude, for example.

The filling station information acquisition unit 10 is a communication unit connected to a wireless communication apparatus. The wireless communication apparatus performs wireless communication with a communication apparatus that is outside the vehicle using a wireless LAN or a public wireless network, and receives information related to filling stations. Information related to a filling station includes position information of the filling station and fuel price information of the filling station, for example. The filling station information acquisition unit 10 provides the acquired information related to filling stations to the control unit 1.

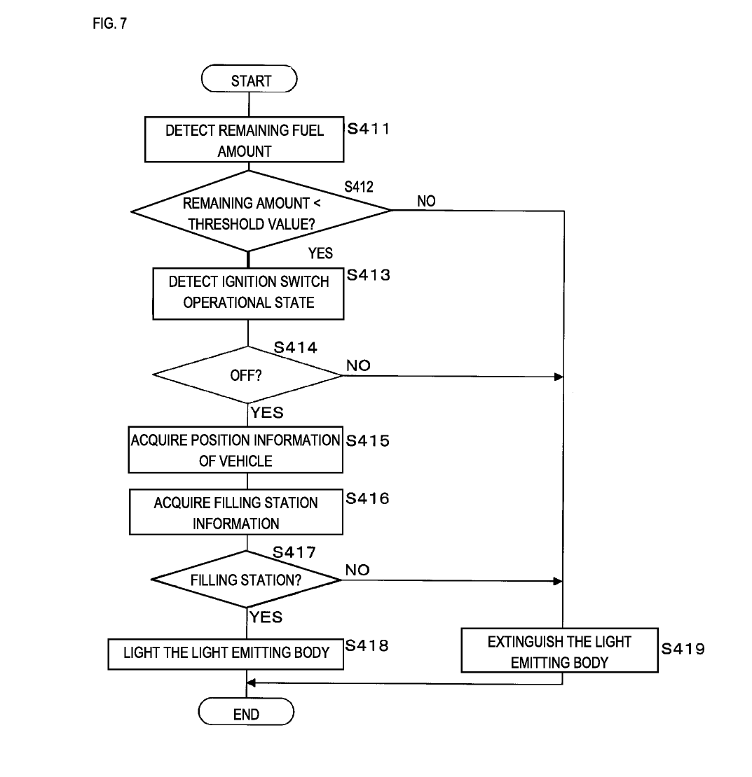

FIG. 7 is a flowchart showing a processing procedure of light emission control according to the fourth embodiment. The control unit 1 detects the remaining amount of fuel with the remaining fuel amount detection unit 3 (step S411), and determines whether the remaining amount of fuel is less than a threshold value (step S412). If it is determined that the remaining amount of fuel is less than the threshold value (step S412: YES), the control unit 1 detects the operational state of the ignition switch with the ignition switch operational state detection unit 4 (step S413), and determines whether the ignition switch is in an OFF state (step S414).

If it is determined that the ignition switch is in an OFF state (step S414: YES), the control unit 1 acquires position information of the vehicle detected with the position detection unit 9 (step S415). The control unit 1 then acquires information related to filling stations with the filling station information acquisition unit 10 (step S416). The position information of filling stations is included in this information. Next, the control unit 1 determines whether the vehicle is located at a filling station, based on the position information of the vehicle acquired at step S415 and the position information acquired at step S416 (step S417). If it is determined that the vehicle is located at a filling station (step S417: YES), the control unit 1 outputs a light emission control signal to the drive unit 6, and the drive unit 6 causes the light emitting body 7 to emit light in accordance with this light emission control signal (step S418), and ends the processing.

If it is determined that the remaining amount of fuel is greater than or equal to the threshold value (step S412: NO), if it is determined that the ignition switch is in an ON state (step S414: NO), or if it is determined that the vehicle is not located at a filling station (step S417: NO), the control unit 1 outputs an extinguishment control signal to the drive unit 6, and the drive unit 6 causes the light emitting body 7 to be extinguished in accordance with this extinguishment control signal (step S419), and ends the processing.

With the in-vehicle light emitting apparatus according to the third embodiment constituted in this manner, the drive unit 6 is able to illuminate the operating part 70 by causing the light emitting body 7 to emit light, when the vehicle has stopped at a filling station and there is a possibility that refueling will be performed.

Note that although this fourth embodiment was described as a variation of the first embodiment, the in-vehicle light emitting apparatus may be constituted by combining the configuration of this fourth embodiment with the second and third embodiments.

### Fifth Embodiment

Since the configuration of an in-vehicle light emitting apparatus according to a fifth embodiment is similar to the fifth embodiment, and only the processing procedure of light emission control differs, the following description will focus mainly on the differences. Since the remaining configuration and the operation and effect are similar to the embodiment, the same reference signs are given to corresponding parts, and a detailed description thereof will be omitted.

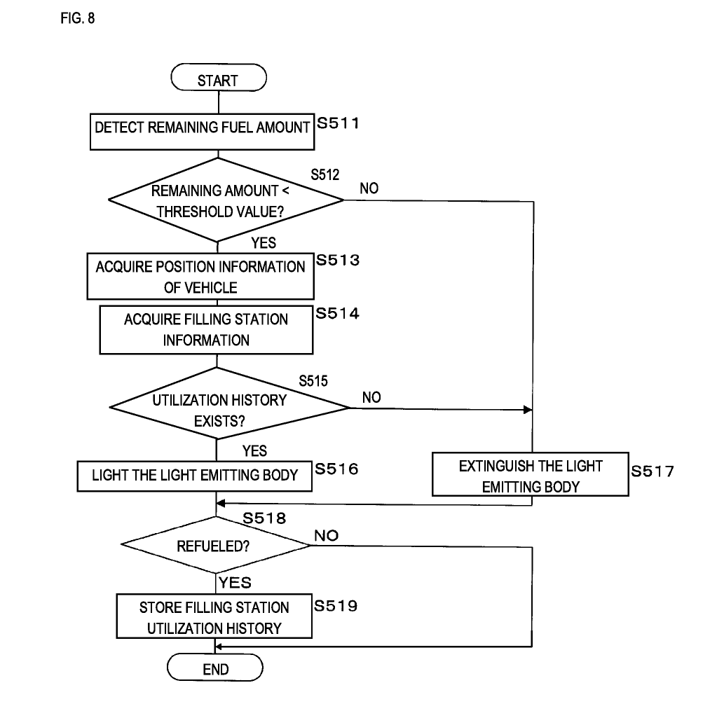

FIG. 8 is a flowchart showing a processing procedure of light emission control according to the fifth embodiment. The control unit 1 detects the remaining amount of fuel with the remaining fuel amount detection unit 3 (step S511), and determines whether the remaining amount of fuel is less than a threshold value (step S512). If it is determined that the remaining amount of fuel is less than the threshold value (step S512: YES), the control unit 1 acquires position information of the vehicle detected with the position detection unit 9 (step S513). The control unit 1 then acquires information related to filling stations that are within a predetermined range from the vehicle with the filling station information acquisition unit 10 (step S514). The position information of the filling stations is included in this information.

Next, the control unit 1 determines whether there is a utilization history for a filling station that is within the predetermined range from the vehicle (step S515). As will be discussed later, the storage unit 2 stores the position information of filling stations at which refueling was performed in the past. The control unit 1 determines whether the position of the filling station that is within the predetermined range from the vehicle corresponds to the position of a filling station at which refueling was performed in the past, based on the position information of the filling stations that is stored in the storage unit 2.

If it is determined that there is a utilization history for the filling station (step S515: YES), the control unit 1 outputs a light emission control signal to the drive unit 6, and the drive unit 6 causes the light emitting body 7 to emit light in accordance with this light emission control signal (step S516).

If it is determined that the remaining amount of fuel is greater than or equal to the threshold value (step S512: NO), or if it is determined that there is no utilization history for the filling station within the predetermined range from the vehicle (step S515: NO), the control unit 1 outputs an extinguishment control signal to the drive unit 6, and the drive unit 6 causes the light emitting body 7 to be extinguished in accordance with this extinguishment control signal (step S517).

The control unit 1, having ended the processing of step S516 or step S517, detects the remaining amount of fuel with the remaining fuel amount detection unit 3, and determines whether refueling has been performed (step S518). For example, in the case where the remaining amount of fuel that is detected with the remaining fuel amount detection unit 3 has increased by a predetermined amount or more during a predetermined time period, it can be determined that refueling has been performed. If it is determined that refueling has been performed (step S518: YES), the control unit 1 stores the current position of the vehicle in the storage unit 2 as the position of a filling station at which refueling was performed (step S519), and ends the processing. If it is determined that refueling has not been performed (step S518: NO), the control unit 1 ends the processing.

With the in-vehicle light emitting apparatus according to the fifth embodiment constituted in this manner, the drive unit 6 causes the light emitting body 7 to emit light, in the case where there is a filling station at which refueling was performed in the past in the vicinity of the vehicle. In other words, in the case where there is a high possibility that refueling will be performed, the drive unit 6 is able to illuminate the operating part 70 by causing the light emitting body 7 to emit light.

### Sixth Embodiment

Since the configuration of an in-vehicle light emitting apparatus according to a sixth embodiment is similar to the fourth embodiment, and only the processing procedure of light emission control differs, the following description will focus mainly on the differences. Since the remaining configuration and the operation and effect are similar to the fourth embodiment, the same reference signs are given to corresponding parts, and a detailed description thereof will be omitted.

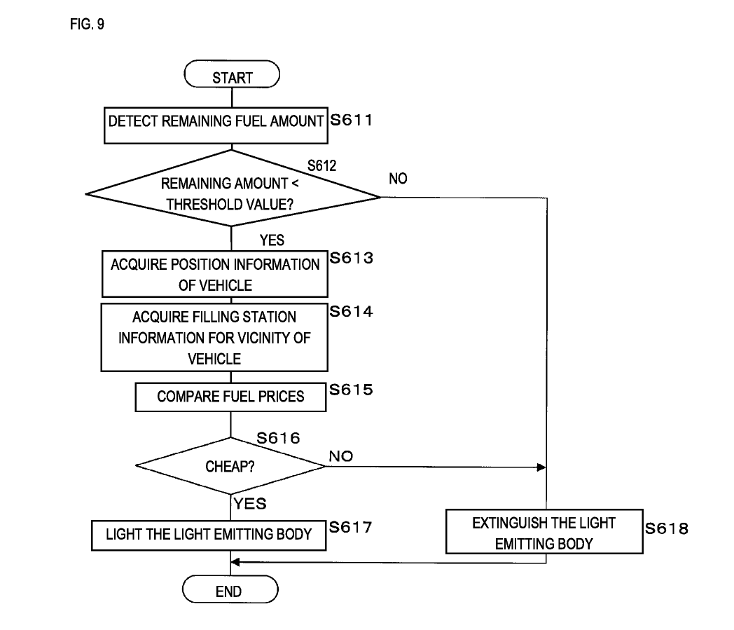

FIG. 9 is a flowchart showing a processing procedure of light emission control according to the sixth embodiment. The remaining amount of fuel is detected with the remaining fuel amount detection unit 3 (step S611), and it is determined whether the remaining amount of fuel is less than a threshold value (step S612). If it is determined that the remaining amount of fuel is less than the threshold value (step S612: YES), the control unit 1 acquires position information of the vehicle detected with the position detection unit 9 (step S613). The control unit 1 then acquires information related to a filling station that is within a predetermined range from the vehicle with the filling station information acquisition unit 10 (step S614).

Next, the control unit 1 compares the fuel price of the filling station that is within the predetermined range from the vehicle with the fuel prices of other filling stations, based on the information related to the filling station acquired at step S614 (step S615). For example, the fuel price of the filling station that is within the predetermined range from the vehicle is compared with the fuel prices of filling stations that are outside of the predetermined range. Note that in the case where there are a plurality of filling stations within the predetermined range from the vehicle, this range can be narrowed until the number of filling stations within the predetermined range is one.

The control unit 1 then determines whether the fuel price of the filling station that is within the predetermined range is cheaper than the fuel prices of the other filling stations (step S616). If it is determined to be cheaper (step S616: YES), the control unit 1 outputs a light emission control signal to the drive unit 6, and the drive unit 6 causes the light emitting body 7 to emit light in accordance with this light emission control signal (step S617).

If it is determined that the remaining amount of fuel is greater than or equal to the threshold value (step S612: NO), or if it is determined that the fuel price of the filling station at which the vehicle is located is not cheaper (step S616: NO), the control unit 1 outputs an extinguishment control signal to the drive unit 6, and the drive unit 6 causes the light emitting body 7 to be extinguished in accordance with this extinguishment control signal (step S618), and ends the processing.

With the in-vehicle light emitting apparatus according to the sixth embodiment constituted in this manner, the drive unit 6 causes the light emitting body 7 to emit light in the case where the filling station within the predetermined range from the vehicle is cheap, and extinguishes the light emitting body 7 in the case where this filling station is expensive. Adopting this configuration enables a cheaper filling station to be suggested to the driver.

### LIST OF REFERENCE NUMERALS

1 Control unit

2 Storage unit

3 Remaining fuel amount detection unit

4 Ignition switch operational state detection unit

5 Engine state detection unit

6 Drive unit

7 Light emitting body

8 Acceptance unit

9 Position detection unit

10 Filling station information acquisition unit

70 Operating part

1. An in-vehicle light emitting apparatus comprising a light emitting body provided in an interior of a vehicle that runs on fuel and a drive unit configured to drive the light emitting body, comprising:
a remaining amount detection unit configured to detect a remaining amount of fuel,
wherein the light emitting body is arranged in an operating part for opening a fuel lid of a refueling port provided in the vehicle or at a location from which the operating part can be illuminated, and
the drive unit causes the light emitting body to emit light, in a case where the remaining amount detected with the remaining amount detection unit is less than a threshold value.

2. (canceled)

3. The in-vehicle light emitting apparatus according to claim 1, comprising:
a remaining amount storage unit configured to store the amount of fuel remaining when refueling is performed; and
a threshold value determining unit configured to determine the threshold value, based on the remaining amount stored in the remaining amount storage unit.

4. The in-vehicle light emitting apparatus according to claim 1, comprising:
an operational state detection unit configured to detect an operational state of an ignition switch,
wherein the drive unit causes the light emitting body to emit light, in a case where the operational state of the ignition switch is an OFF state.

5. The in-vehicle light emitting apparatus according to claim 1, comprising:
an engine state detection unit configured to detect a state of an engine of the vehicle,
wherein the drive unit causes the light emitting body to emit light, in a case where the engine has stopped.

6. The in-vehicle light emitting apparatus according to claim 1, comprising:
an acquisition unit configured to acquire position information of the vehicle;
a filling station information acquisition unit configured to acquire position information of a filling station; and
a position determination unit configured to determine, based on the position information acquired with the acquisition unit and the position information of the filling station, whether the vehicle is at the filling station,
wherein the drive unit causes the light emitting body to emit light, in a case where it is determined that the vehicle is at the filling station.

7. The in-vehicle light emitting apparatus according to claim 1, comprising:
an acquisition unit configured to acquire position information of the vehicle;
a position storage unit configured to store position information that the acquisition unit acquires when refueling is performed; and
a utilized filling station determination unit configured to determine whether a filling station is within a predetermined range from the vehicle, based on the position information acquired with the acquisition unit and the position information stored in the position storage unit,
wherein the drive unit causes the light emitting body to emit light, in a case where it is determined that the filling station is within the predetermined range.

8. The in-vehicle light emitting apparatus according to claim 1, comprising:
an acquisition unit configured to acquire position information of the vehicle;
a filling station information acquisition unit configured to acquire position information and information related to a fuel price of a filling station;
a filling station determination unit configured to determine whether a filling station is within a predetermined range from the vehicle, based on the position information acquired with the acquisition unit and the position information of the filling station; and
a fuel price comparison unit configured to, in a case where it is determined that the filling station is within the predetermined range, compare the fuel price of the filling station with the fuel price of another filling station,
wherein the drive unit causes the light emitting body to emit light according to a comparison result of the fuel price comparison unit, in a case where it is determined that the filling station is within the predetermined range.

9. The in-vehicle light emitting apparatus according to claim 3, comprising:
an operational state detection unit configured to detect an operational state of an ignition switch,
wherein the drive unit causes the light emitting body to emit light, in a case where the operational state of the ignition switch is an OFF state.

10. The in-vehicle light emitting apparatus according to claim 3, comprising:
an engine state detection unit configured to detect a state of an engine of the vehicle,
wherein the drive unit causes the light emitting body to emit light, in a case where the engine has stopped.

11. The in-vehicle light emitting apparatus according to claim 4, comprising:
an engine state detection unit configured to detect a state of an engine of the vehicle,
wherein the drive unit causes the light emitting body to emit light, in a case where the engine has stopped.

12. The in-vehicle light emitting apparatus according to claim 3, comprising:
an acquisition unit configured to acquire position information of the vehicle;
a filling station information acquisition unit configured to acquire position information of a filling station; and
a position determination unit configured to determine, based on the position information acquired with the acquisition unit and the position information of the filling station, whether the vehicle is at the filling station,
wherein the drive unit causes the light emitting body to emit light, in a case where it is determined that the vehicle is at the filling station.

13. The in-vehicle light emitting apparatus according to claim 4, comprising:
an acquisition unit configured to acquire position information of the vehicle;
a filling station information acquisition unit configured to acquire position information of a filling station; and
a position determination unit configured to determine, based on the position information acquired with the acquisition unit and the position information of the filling station, whether the vehicle is at the filling station,
wherein the drive unit causes the light emitting body to emit light, in a case where it is determined that the vehicle is at the filling station.

14. The in-vehicle light emitting apparatus according to claim 5, comprising:
an acquisition unit configured to acquire position information of the vehicle;
a filling station information acquisition unit configured to acquire position information of a filling station; and
a position determination unit configured to determine, based on the position information acquired with the acquisition unit and the position information of the filling station, whether the vehicle is at the filling station,
wherein the drive unit causes the light emitting body to emit light, in a case where it is determined that the vehicle is at the filling station.

15. The in-vehicle light emitting apparatus according to claim 3, comprising:
an acquisition unit configured to acquire position information of the vehicle;
a position storage unit configured to store position information that the acquisition unit acquires when refueling is performed; and
a utilized filling station determination unit configured to determine whether a filling station is within a predetermined range from the vehicle, based on the position information acquired with the acquisition unit and the position information stored in the position storage unit,
wherein the drive unit causes the light emitting body to emit light, in a case where it is determined that the filling station is within the predetermined range.

16. The in-vehicle light emitting apparatus according to claim 4, comprising:
an acquisition unit configured to acquire position information of the vehicle;
a position storage unit configured to store position information that the acquisition unit acquires when refueling is performed; and
a utilized filling station determination unit configured to determine whether a filling station is within a predetermined range from the vehicle, based on the position information acquired with the acquisition unit and the position information stored in the position storage unit,
wherein the drive unit causes the light emitting body to emit light, in a case where it is determined that the filling station is within the predetermined range.

17. The in-vehicle light emitting apparatus according to claim 5, comprising:
an acquisition unit configured to acquire position information of the vehicle;
a position storage unit configured to store position information that the acquisition unit acquires when refueling is performed; and
a utilized filling station determination unit configured to determine whether a filling station is within a predetermined range from the vehicle, based on the position information acquired with the acquisition unit and the position information stored in the position storage unit,
wherein the drive unit causes the light emitting body to emit light, in a case where it is determined that the filling station is within the predetermined range.

18. The in-vehicle light emitting apparatus according to claim 3, comprising:
an acquisition unit configured to acquire position information of the vehicle;
a filling station information acquisition unit configured to acquire position information and information related to a fuel price of a filling station;
a filling station determination unit configured to determine whether a filling station is within a predetermined range from the vehicle, based on the position information acquired with the acquisition unit and the position information of the filling station; and
a fuel price comparison unit configured to, in a case where it is determined that the filling station is within the predetermined range, compare the fuel price of the filling station with the fuel price of another filling station,
wherein the drive unit causes the light emitting body to emit light according to a comparison result of the fuel price comparison unit, in a case where it is determined that the filling station is within the predetermined range.

19. The in-vehicle light emitting apparatus according to claim 4, comprising:
an acquisition unit configured to acquire position information of the vehicle;
a filling station information acquisition unit configured to acquire position information and information related to a fuel price of a filling station;
a filling station determination unit configured to determine whether a filling station is within a predetermined range from the vehicle, based on the position information acquired with the acquisition unit and the position information of the filling station; and
a fuel price comparison unit configured to, in a case where it is determined that the filling station is within the predetermined range, compare the fuel price of the filling station with the fuel price of another filling station,
wherein the drive unit causes the light emitting body to emit light according to a comparison result of the fuel price comparison unit, in a case where it is determined that the filling station is within the predetermined range.

20. The in-vehicle light emitting apparatus according to claim 5, comprising:
an acquisition unit configured to acquire position information of the vehicle;
a filling station information acquisition unit configured to acquire position information and information related to a fuel price of a filling station;
a filling station determination unit configured to determine whether a filling station is within a predetermined range from the vehicle, based on the position information acquired with the acquisition unit and the position information of the filling station; and
a fuel price comparison unit configured to, in a case where it is determined that the filling station is within the predetermined range, compare the fuel price of the filling station with the fuel price of another filling station,
wherein the drive unit causes the light emitting body to emit light according to a comparison result of the fuel price comparison unit, in a case where it is determined that the filling station is within the predetermined range.
